(19) United States
(12) Patent Application Publication
(10) Pub. No.: US 2010/0086234 A1
(43) Pub. Date: Apr. 8, 2010

(54) SYSTEM AND METHOD FOR PRESERVING EDITING HISTORY IN AN IN-BROWSER PHOTO-EDITING APPLICATION

(75) Inventors: Darrin Massena, Seattle, WA (US); Michael Harrington, Seattle, WA (US)

Correspondence Address: GRAYBEAL JACKSON LLP, 400 - 108TH AVENUE NE, SUITE 700, BELLEVUE, WA, 98004, US

(73) Assignee: BITNIK, INC., Seattle, WA (US)

(21) Appl. No.: 12/245,424

(22) Filed: Oct. 3, 2008

(51) Int. Cl. G06K 9/03

(52) U.S. Cl. 382/311

(57) ABSTRACT

A system and method for preserving and retrieving editing history of a digital image. One method includes identifying a user of an in-browser photo-editing application, retrieving a plurality of digital photographs from a data store, the plurality of digital photographs associated with at least one previous photo-editing session of the identified user, and presenting selectable images of the retrieved digital photographs on a display, each image having an associated editing history. Such a system and method provides several advantages over the prior art. First, as a user may manipulate images over the course of time in various manners with various editing programs, the entire history of such edits may be preserved. Having the editing history known and retrievable allows the user to undo any or all editing manipulations to return to an original digital image as it was originally stored in the system.

### BACKGROUND OF THE INVENTION

Digital photo editing and digital photo editors are common in today's digital photography technology. In digital editing, photographs are typically taken with a digital camera and input directly into a computer for storage and manipulation. Additionally, traditional printed photograph may be digitized using a scanner and also stored and manipulated on a computer. Photos can also be stored and obtained from stock photography databases. With the advent of computers, graphics tablets, and digital cameras, the term photo editing encompasses everything that can be done to a photo in a darkroom or on a computer. Photo editing is most commonly subtle (e.g. alterations to coloring, contrast, so forth), but may be explicit also (e.g. overlaying a head onto a different body, changing a sign's text). Image editing software can be used to apply effects and warp an image in whatever way possible until the desired result is achieved. Image editing software can also be used to create images from scratch for example with tools for drawing or adding text. Sometimes, after photo editing, the resulting image has little or no resemblance to the photo from which it started.

Digital image editing computer programs are prevalent and easily accessible and provide a means that allows any computer to be used for digital photo editing. Often times, a standalone software package may be purchased and installed on a personal computer or in a computer networking environment. These conventional software programs allow for digital photos to be manipulated and saved at the local machine in which the photo editing software is running. Thus, a user of personal computer with such photo editing software may easily manipulate any number of digital photos that are also stored at that computer. In this scenario, the task-intensive steps of actual photo manipulation are accomplished by the personal computer.

Further, various networking environments may allow photo editing software to be run at some accessible server computer such that images are manipulated at the server computer at the behest of the connected client computer. In this scenario, the task-intensive steps of actual photo manipulation are accomplished by the server computer that hosts the photo editing software and the client computer merely acts as a controller.

With the advent of web sites and server farms capable of storing a tremendous amount of data, various computer users have begun storing digital photos in online storage services. In this manner, a person may access stored digital photos from any computer that the person may be using. With universal access to stored digital photos, one may upload photos from virtually anywhere and store the digital photos in an online manner. However, well-known and comprehensive photo editing software may only be resident on one personal computer or within a specific network of computers. Thus, even if a person is able to upload and store their newly created digital photos from any computer connected to the internet, the person cannot access their photo editing software to manipulate the newly created and stored digital photos.

Furthermore, the editing, manipulation, saving and storing of digital photographs may occur at several different locations with respect to the network of various photo-storing and photo-sharing websites and the like. For example, an initial digital photograph may be uploaded to a social networking site (e.g., MySpace™) and slightly manipulated for upload. Later, a user may choose to transfer the digital photograph to photo-sharing website (e.g., Flickr™) for use within that site. Again, the photo may be edited and manipulated there as well. Next a user may download the digital photograph from Flickr™ in order to manipulate the digital photograph at a local personal computer (e.g., using Adobe Photoshop™) and then upload the digital photograph yet again to yet another website (e.g., Yahoo!™). As such, the permutations of manipulation and editing are substantial and after several image manipulations, the original state of the digital photograph becomes compromised. With the various manners and methods in which a user may typically transfer, edit, manipulate and store digital photographs, one could easily save an improper edit or undesirable edit (cropping off people's heads, saving in black and white only, etc.) with no recourse for restoring the original digital photograph or at least a previous version.

What is needed is a more suitable and convenient manner of tracking and maintaining editing history of digital photograph across a networked environment of web services and computer applications.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 shows a diagram of a suitable computing environment for practicing various aspects of an in-browser photo editing system and method according to an embodiment of an invention disclosed herein;

FIG. 2 is a diagram of a suitable computing network for practicing various aspects of an in-browser photo editing system and method according to an embodiment of an invention disclosed herein;

FIG. 3 is a flow chart of a method for preserving and recalling editing history with regard to a digital photograph according to an embodiment of an invention disclosed herein;

FIG. 4 is a screenshot of an in-browser photo-editing application suitable for presenting a selection of digital photographs associated with a database of historical data related to image manipulation according to an embodiment of an invention disclosed herein; and

FIG. 5 is a screenshot of an in-browser photo-editing application suitable for providing editing options of digital photographs associated with a database of historical data related to image manipulation according to an embodiment of an invention disclosed herein.

### DETAILED DESCRIPTION

The following discussion is presented to enable a person skilled in the art to make and use the subject matter disclosed herein. The general principles described herein may be applied to embodiments and applications other than those detailed above without departing from the spirit and scope of the subject matter disclosed herein. This disclosure is not intended to be limited to the embodiments shown, but is to be accorded the widest scope consistent with the principles and features disclosed or suggested herein.

By way of overview, an embodiment of the invention disclosed herein is described in the following paragraphs. One embodiment comprises a system and method for identifying a user of an in-browser photo-editing application, retrieving a plurality of digital photographs from a data store, the plurality of digital photographs associated with at least one previous photo-editing session of the identified user, and presenting selectable images of the retrieved digital photographs on a display, each image having an associated editing history.

Such a system and method provides several advantages over the prior art. First, as a user may manipulate images over the course of time in various manners with various editing programs, the entire history of such edits may be preserved. Having the editing history known and retrievable allows the user to undo any or all editing manipulations to return to an original digital image as it was originally stored in the system. Further, the user may choose to exchange, remove, or interchange edits as desired, allowing additionally functionality and ability to recall edits and manipulation instructions. Such an editing history, that typically includes all editing instructions requested an implemented during any editing session (e.g., anytime a user authenticates and uses an in-browser photo editing application as described below) along with a chronological order of implementation of said instruction and saved versions of the manipulated image. Thus, a user has a powerful array of information available to tailor an editing history according to style and preference.

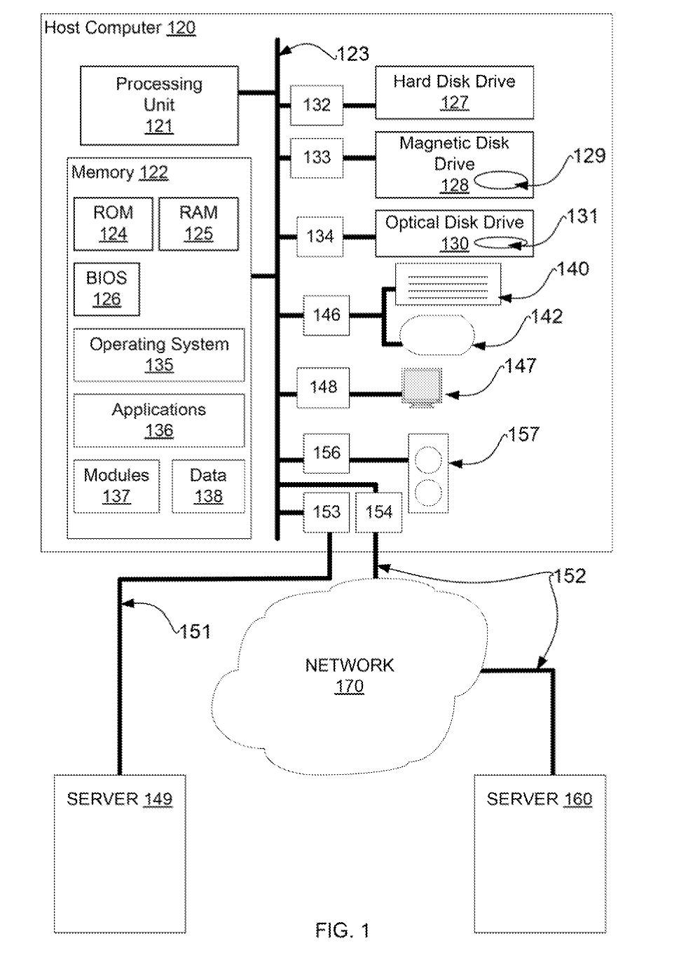

FIG. 1 and the following discussion are intended to provide a brief, general description of a suitable computing environment in which the subject matter disclosed herein may be implemented. Although not required, aspects of a system and method for preserving editing history of a digital image as may be used within an in-browser photo editing system and method will be described in the general context of computer-executable instructions, such as program modules, being executed by a personal computer. Generally, program modules include routines, programs, objects, components, data structures, etc., that perform particular tasks or implement particular abstract data types. Moreover, those skilled in the art will appreciate that the invention may be practiced with other computer system configurations, including hand-held devices, cellular or mobile telephones, multiprocessor systems, microprocessor-based or programmable consumer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices.

With reference to FIG. 1, an exemplary system for implementing the systems and methods disclosed herein includes a general purpose computing device in the form of a conventional personal computer 120, including a processing unit 121, a system memory 122, and a system bus 123 that couples various system components including the system memory to the processing unit 121. The system bus 123 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The system memory includes read only memory (ROM) 124 and random access memory (RAM) 125. A basic input/output system (BIOS) 126, containing the basic routines that help to transfer information between elements within the personal computer 120, such as during start-up, is stored in ROM 124. The personal computer 120 further includes a hard disk drive 127 for reading from and writing to a hard disk, not shown, a magnetic disk drive 128 for reading from or writing to a removable magnetic disk 129, and an optical disk drive 30 for reading from or writing to a removable optical disk 131 such as a CD ROM or other optical media. The hard disk drive 127, magnetic disk drive 128, and optical disk drive 130 are connected to the system bus 123 by a hard disk drive interface 132, a magnetic disk drive interface 133, and an optical drive interface 134, respectively. The drives and their associated computer-readable media provide nonvolatile storage of computer readable instructions, data structures, program modules and other data for the personal computer 120. Although the exemplary environment described herein employs a hard disk, a removable magnetic disk 129 and a removable optical disk 131, it should be appreciated by those skilled in the art that other types of computer-readable media which can store data that is accessible by a computer, such as magnetic cassettes, flash memory cards, digital versatile disks, Bernoulli cartridges, random access memories (RAMs), read only memories (ROM), and the like, may also be used in the exemplary operating environment.

A number of program modules may be stored on the hard disk, magnetic disk 129, optical disk 131, ROM 124 or RAM 125, including an operating system 135, one or more application programs 136, other program modules 137, and program data 138. A user may enter commands and information into the personal computer 120 through input devices such as a keyboard 140 and pointing device 142. Other input devices (not shown) may include a microphone, joystick, game pad, satellite dish, scanner, or the like. These and other input devices are often connected to the processing unit 121 through a serial port interface 146 that is coupled to the system bus, but may be connected by other interfaces, such as a parallel port, game port or a universal serial bus (USB). A monitor 147 or other type of display device is also connected to the system bus 123 via an interface, such as a video adapter 148. One or more speakers 157 are also connected to the system bus 123 via an interface, such as an audio adapter 156. In addition to the monitor and speakers, personal computers typically include other peripheral output devices (not shown), such as printers.

The personal computer 120 operates in a networked environment using logical connections to one or more remote computers, such as remote computers 149 and 160. Each remote computer 149 or 160 may be another personal computer, a server, a router, a network PC, a peer device or other common network node, and typically includes many or all of the elements described above relative to the personal computer 320, although only a memory storage device 150 or 161 has been illustrated in FIG. 1. The logical connections depicted in FIG. 1 include a local area network (LAN) 151 and a wide area network (WAN) 152. Such networking environments are commonplace in offices, enterprise-wide computer networks, intranets and the Internet. As depicted in FIG. 1, the remote computer 160 communicates with the personal computer 120 via the local area network 151. The remote computer 149 communicates with the personal computer 120 via the wide area network 152.

When used in a LAN networking environment, the personal computer 120 is connected to the local network 151 through a network interface or adapter 153. When used in a WAN networking environment, the personal computer 120 typically includes a modem 154 or other means for establishing communications over the wide area network 152, such as the Internet. The modem 154, which may be internal or external, is connected to the system bus 123 via the serial port interface 146. In a networked environment, program modules depicted relative to the personal computer 120, or portions thereof, may be stored in the remote memory storage device. It will be appreciated that the network connections shown are exemplary and other means of establishing a communications link between the computers may be used.

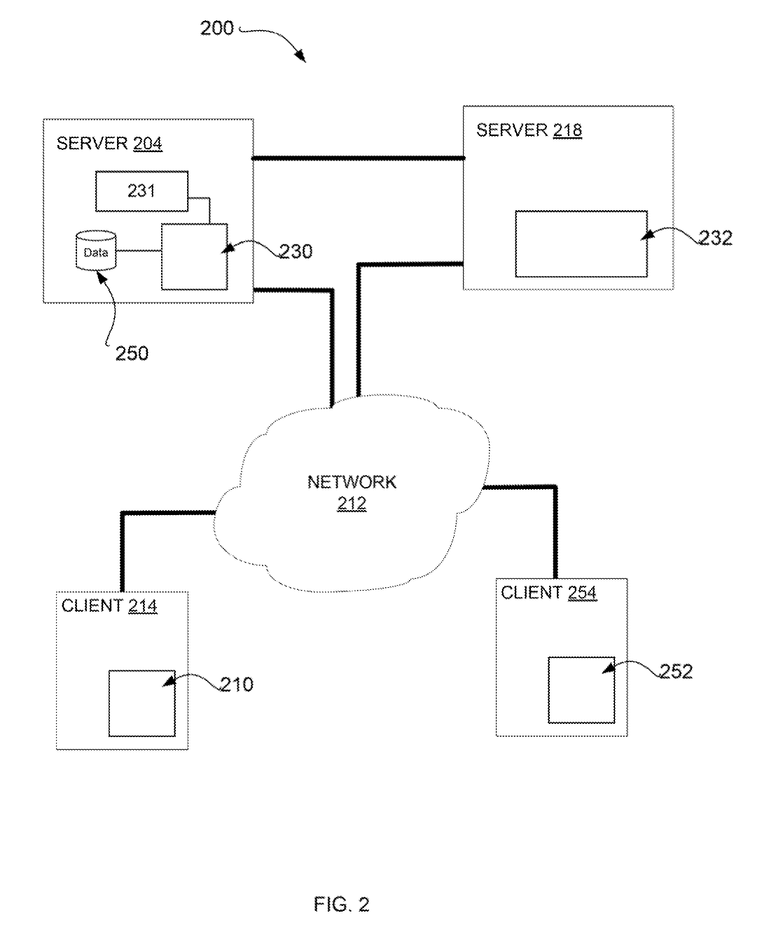

FIG. 2 illustrates an exemplary architecture of a networked computer system in which aspects of an in-browser photo editing application may be practiced. The computer network 216 may be a local area network 151 (FIG. 1), a wide area network 152 (FIG. 1), or a combination of networks that allow the server computer 204 to communicate with remote computers, such as the remote server computer 218, either directly or indirectly. The server computer 204 and the remote server computer 218 are typically similar to the personal computer 120 depicted in FIG. 1 and discussed above.

Such a computer network 216 allows for the sending and receiving of data associated with digital images that may be used with an in-browser photo editing system. Such data may be stored in a database 250 on a server computer 204. This data may be updated, assimilated and/or altered according to additional data sent and received to and from various other computers in the computer network such as server computer 218 and client computers 214 and 254.

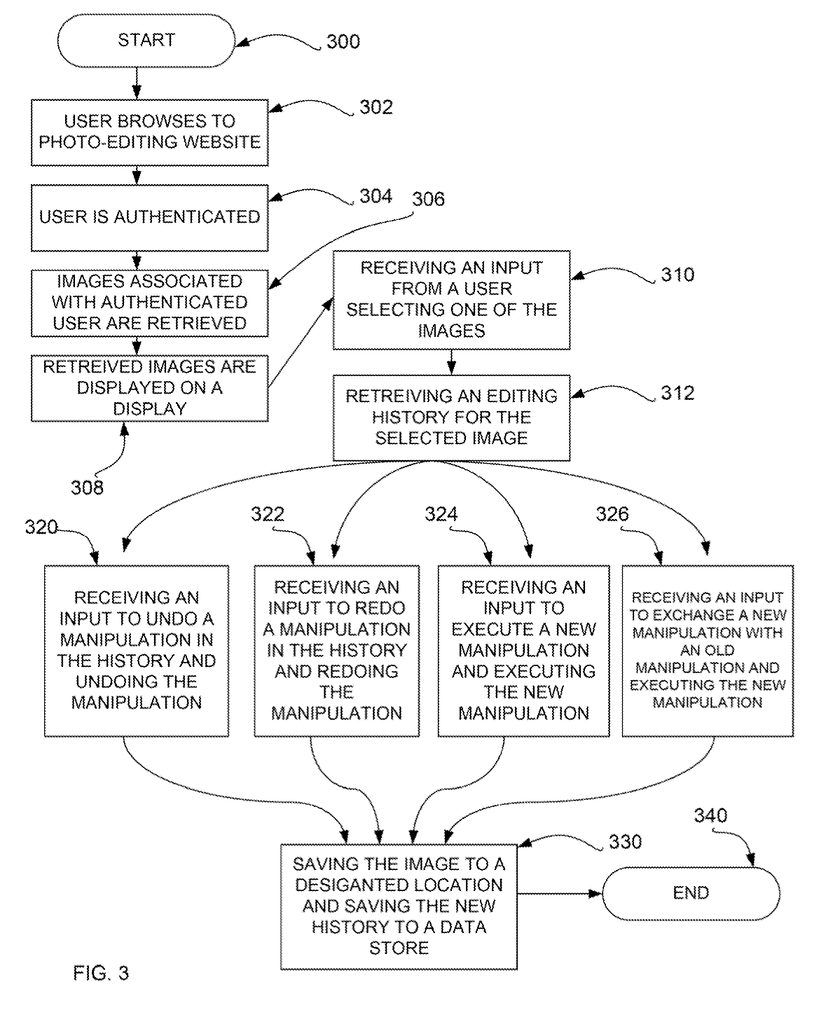

With such a computer network, a system for manipulating digital image in a computer-network environment may be realized. A typical system includes a client computer 214 having a web browser application executing thereon and having an in-browser image manipulation application executing within the context of the web browser application. Typically, a client computer will have a dedicated web browsing application, such as Internet Explorer™ from the Microsoft™ Corporation such that when browsing web pages over the Internet, a set of default rules and applications are implemented to accomplish all web-browser related activities. The web browser application may also be any other common web browser such as Mozilla Firefox, Netscape Navigator, and Safari. The web browser may be used to navigate and utilize web sites and web applications. One specific web application may be an in-browser photo editor as described herein. This in-browser photo editor and methods associated therewith are described in more detail below with respect to FIG. 3.

The system may further include a server computer 254 communicatively coupled to the client computer 214 over the computer network. In one embodiment, the server computer includes an image manipulation service executing thereon, such that a client computer 214 may invoke the service via the Internet connection. With that, the in-browser photo editor includes an image manipulation application that is operable to handle a number of image manipulation tasks. In an abstract form then, the application may receive an instruction for manipulating an image (e.g., an instruction to crop, rotate, resize, etc.) and determine whether the manipulation is more efficiently executed at the client computer 214 or at the server computer 218.

The system may further include a remote computer 254 communicatively coupled to the client computer 214 and the server computer 254. The remote computer may be used for additional storage and manipulation of images such that it is operable to store digital images for the client computer 214 to retrieve for manipulation.

Within the context of such a system as shown in FIG. 2, one system embodiment may typically comprise a client computer 214 having a web browser application 210 executing thereon and having an in-browser image manipulation application executing within the context of the web browser application. Further, the system may include a server computer 204 communicatively coupled to the client computer 214 over a computer network 212, the server computer 204 having a plurality of images stored thereon in a data store 250, each image associated with an editing history. The in-browser image manipulation application is operable to identify a user of the in-browser image manipulation application and also operable to retrieve at least one of the plurality of stored images from the server computer 204 and its associated editing history. Then the retrieved images and their associated editing histories may be shown on a display at the client computer 214.

As discussed above, the associated editing history typically comprises a series of image manipulations in a set order of execution in which the user may have implemented during a previous editing session. In this embodiment, the associated editing history is stored at the server computer 204 with its associated image in the data store 250 and typically handled via a web service 230 executing thereon with an associated authentication service 231. In other embodiments, the images may actually be stored at a different location, such as at server computer 218 in a data store 232 associated with that server computer. This scenario may be synonymous with remotely storing images using another web service such as Facebook™ or Flickr™. Similarly, the editing history may be stored at any computer as well including the potential of an additional client computer 254 in a local data store 252. Various methods associated with the system described in FIG. 2 are presented below with respect to FIGS. 3-5.

FIG. 3 shows a flow diagram of a method for retrieving and storing an editing history of an image using an in-browser photo editing application according to an embodiment of an invention disclosed herein. The method of FIG. 3 may typically be carried out in a computer networking environment as described above and in the form of computer-executable instructions encoded on a computer-readable medium.

As an overview, one method may typically include identifying a user of an in-browser photo-editing application, retrieving a plurality of digital photographs from a data store, the plurality of digital photographs associated with at least one previous photo-editing session of the identified user, and presenting selectable images of the retrieved digital photographs on a display, each image having an associated editing history. Additionally, another method may typically include displaying an image for manipulation, manipulating the image in a series of user-selected image manipulation instructions, and saving a copy of the image after each manipulation in a data store, wherein each saved copy of the image corresponds to a rendered image just prior to the next manipulation in the series of user-selected image manipulations. These various methods and permutations thereof are described in greater detail in the context of the flow chart of FIG. 3 and in the paragraphs that follow.

In FIG. 3, the method shown herein starts at step 300. The method is typically practiced on a personal computer (such as the personal computer of FIG. 1) and typically employs a suitable web-browsing application such as Microsoft Internet Explorer™ or Firefox™. At step 302, a user may browse to a photo-editing website using the web-browser application of the personal computer. Such an in-browser photo-editing application is described in further detail in separate related U.S. patent application Ser. No. 12/051,337 entitled “SYSTEM AND METHOD FOR IN-BROWSER PHOTO EDITING” and is hereby incorporated by reference.

Once the initial website is displayed on a display, the user may choose to authenticate by engaging in an authentication procedure at step 304. The authentication procedure allows the user to be identified and provide access to data stored on one or more server computers, such as stored digital images and photographs as well as associated editing histories for each stored image or photograph. The authentication procedure may typically be a cookie-based identity schema or a username and password schema as is known in the art.

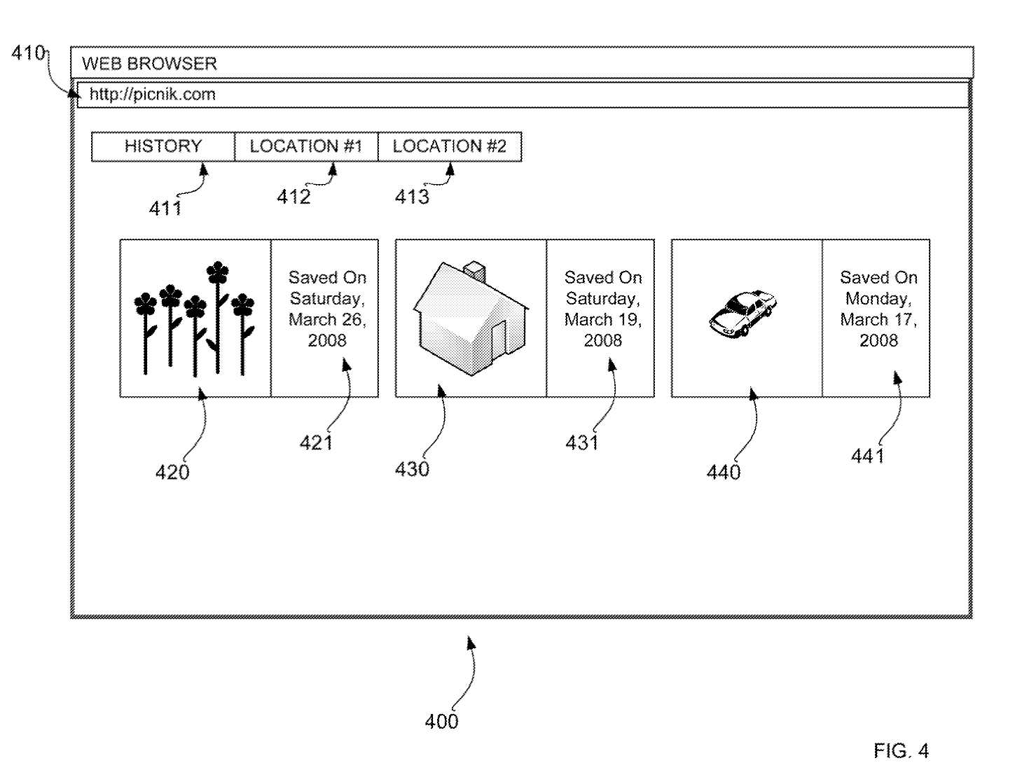

Once authenticated, the method continues at step 306 where one or more digitals images (or digital photographs as may be used interchangeably) associated with the authenticated user may be retrieved from a data store. The data store may be a remote data store or a local data store. Further, the data store may require a further negotiated authentication from a third party website (e.g., Flickr™, Facebook™, etc.). Such negotiation of additional authentication may be automated via a background application such that the retrieval of the images is transparent to the user. Once retrieved, the images may then be displayed on a display at step 308, typically as a thumbnail so that more than one image may be displayed in one view of a webpage. Further, as each image is displayed, additional information may typically be displayed along with each thumbnail, such as last editing session and last saved image date and time. This view of the display at this point in the method is shown with detail in FIG. 4 and is discussed next before proceeding with the remainder of the method of FIG. 3.

FIG. 4 is a screenshot of an in-browser photo-editing application suitable for presenting a selection of digital photographs associated with a database of historical data related to image manipulation according to an embodiment of an invention disclosed herein. In this screenshot 400, a typical address bar 410 shows a website that a user may browse to engage the method of FIG. 3. Here, a user may have already been authenticated and several images have been retrieved and displayed. A first image thumbnail 420 of an image of flowers is shown first with associated set of first image data 421, such as when the image was last saved. Likewise, a second image thumbnail 430 of a house and its associated image data 431 as well as a third image thumbnail 440 with its associated image data 441 is displayed in this view.

Additional controls may be present for the user to retrieve more images, such as additional history 411, location #1 412, and location #2 413 that may correspond to remote web services such as Flickr™ and Facebook™. These options are discussed in more detail as the discussion returns to the method of FIG. 3.

The method continues at step 310 as a user may choose to select one of the displayed images. As such, a user input, such as a mouse-click, may be received to select one of the plurality of displayed images. Then at step 312, an editing history including manipulation instructions associated with the at least one previous photo-editing session may be retrieved from a data store. The editing history may be stored locally in a local data store, at a server computer associated with the website provider or a third party data store. Again, any third party authentication that may be required may occur in an automatic and transparent manner after the user has been authenticated to the initial web service.

The method then moves to a number of optional steps for a user (steps 320, 322, 324, and 326). A user may choose to invoke none, some or all of these steps depending on how the user wishes to manipulate the selected image. As such, at step 320, a user may enter a command to actuate a user interface operable to undo at least one of the manipulation instructions from the retrieved editing history. Further, at step 322, a user may enter a command to actuate a user interface operable to redo at least one of the manipulation instructions. Still further, at step 324, a user may enter a command to actuate a user interface operable to execute at least one new manipulation instruction. Finally, at step 326, a user may enter a command to actuate a user interface operable to exchange a new image manipulation with an old image manipulation as part of a new editing history associated with the digital image.

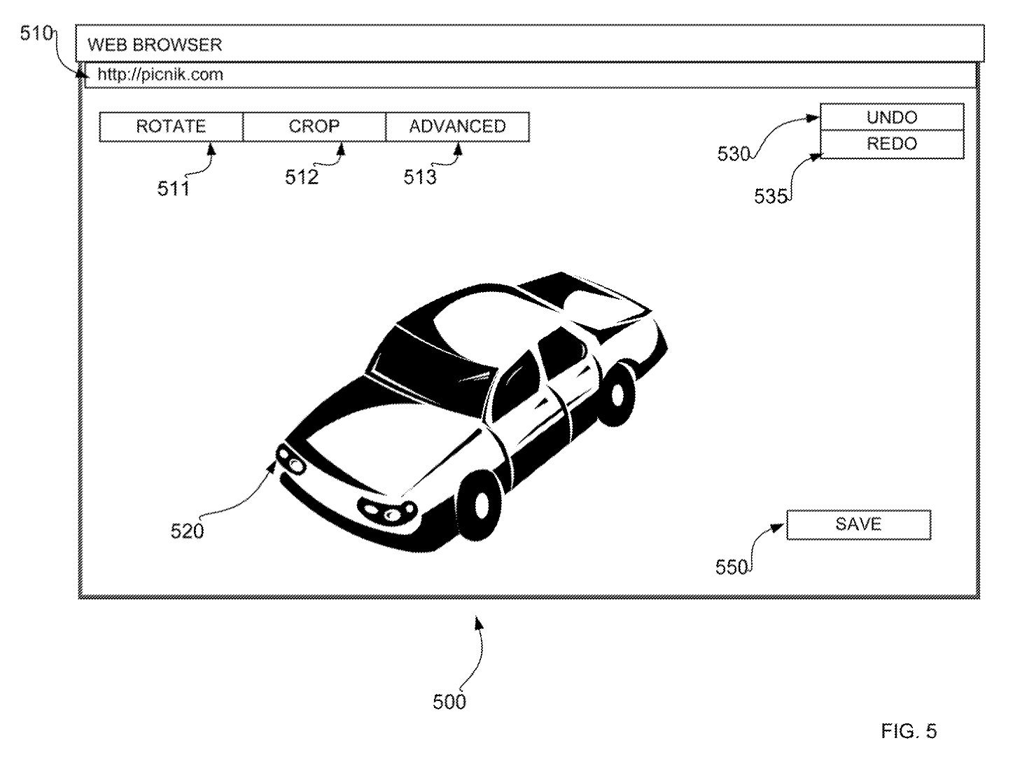

Once any or all of these editing history manipulations have been invoked by the user, a new editing history may be saved to a local or remote data store (typically the same data store from which the editing history was retrieved) at step 330. The method may then end at step 340. These editing manipulations may be further understood in the context of examples in conjunction with the screenshot of FIG. 5 described in the next paragraphs.

FIG. 5 is a screenshot of an in-browser photo-editing application suitable for providing editing options of digital photographs associated with a database of historical data related to image manipulation according to an embodiment of an invention disclosed herein. In this screenshot 500, a digital image of a car 520 has been selected and displayed as a full image (as opposed to a thumbnail in the previous screenshot 400 of FIG. 4). Again, a Web address bar 510 may be present near the top of the screen shot 500. From the screen, a user has a number of options for manipulating an editing the image 520 within the context of her retrieved editing history associated with the image of the car.

Two such options are shown in the upper right-hand corner as an undo instruction 530 and a redo instruction 535 embodied in the form of user selectable interface buttons. Further, additional user interface buttons are shown with typical image manipulation instructions available to the user. In the upper left-hand corner of the screen shot, there is shown three examples of additional image manipulation instructions available for the user to implement: a rotate instruction 511, a crop instruction 512, and an advanced menu selection 512 which may allow the user to browse to yet another webpage having additional and more advanced image manipulation instructions available. Those skilled in the art will understand that any number of image manipulation instructions may be available to user of an in browser photo editing application such as the one discussed throughout this disclosure. Finally, at any time during current editing session, the user may save a new history (i.e., a new series of manipulation instructions based on the choices the user has made in manipulating the image of the car 520.

An additional aspect of a method disclosed herein includes the concept of perfect memory. Briefly, perfect memory involves a method in an in-browser image editing computer application, comprising displaying an image for manipulation, manipulating the image in a series of user-selected image manipulation instructions; and saving the specific sequence of manipulations in a data store. That is, each and every instruction in the series of instructions in an image's editing history is associated with the image at that point in the editing history. Having each manipulation instruction stored with the image itself allows a user to quickly and easily move forward and backward in the series of manipulation instructions within an editing history. A user may store saved copies of the image at a data store that is in a remote location with respect to in-browser image editing computer application and store instructions with each copy of the image for undoing the associated image manipulation. Thus, any specific manipulation instruction may be removed from the series of manipulation instructions at any point without affecting the rest of the series of manipulation instructions.

In an alternative embodiment, perfect memory involves a method in an in-browser image editing computer application, comprising displaying an image for manipulation, manipulating the image in a series of user-selected image manipulation instructions; and saving a copy of the image after each manipulation in a data store, wherein each saved copy of the image corresponds to a rendered image just prior to the next manipulation in the series of user-selected image manipulations. That is, each and every instruction in the series of instructions in an image's editing history is associated with a rendered version of the image at that point in the editing history. Having image stored in each every manipulation instruction allows a user to quickly and easily move forward and backward in the series of manipulation instructions within an editing history. A user may store saved copies of the image at a data store that is in a remote location with respect to in-browser image editing computer application and store instructions with each copy of the image for undoing the associated image manipulation. Thus, any specific manipulation instruction may be removed from the series of manipulation instructions at any point without affecting the rest of the series of manipulation instructions.

While the subject matter discussed herein is susceptible to various modifications and alternative constructions, certain illustrated embodiments thereof are shown in the drawings and have been described above in detail. Furthermore, those skilled in the art will understand that various aspects described in less than all of the embodiments may, nevertheless, be present in any embodiment. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In an in-browser photo editing computer application, a method comprising:
identifying a user of an in-browser photo-editing application;
retrieving a plurality of digital photographs from a data store, the plurality of digital photographs associated with the identified user; and
presenting selectable images of the retrieved digital photographs on a display, each image having an associated editing history.

2. The method of claim 1 wherein the identifying further comprises a cookie-based identity schema.

3. The method of claim 1 wherein the identifying further comprises an authentication schema with a username and password.

4. The method of claim 1, further comprising:
receiving a user input to select one of the plurality of digital photographs;
retrieving the editing history including manipulation instructions associated with the at least one previous photo-editing session; and
displaying a user interface operable to undo at least one of the manipulation instructions.

5. The method of claim 4, further comprising displaying a user interface operable to redo at least one of the manipulation instructions.

6. The method of claim 4, further comprising displaying a user interface operable to execute at least one new manipulation instruction.

7. The method of claim 4, further comprising providing a user interface operable to save a new set of manipulation as a new editing history associated with the digital photograph.

8. The method of claim 1, wherein retrieving a plurality of digital photographs from a data store further comprises:
receiving an instruction from a user to retrieve the plurality of digital photographs from a remote data store; and
automatically authenticating the user to the remote data store.

9. A system for editing a digital image, the system comprising:
a client computer having a web browser application executing thereon and having an in-browser image manipulation application executing within the context of the web browser application; and
a server computer communicatively coupled to the client computer over a computer network, the server computer having a plurality of images stored thereon, each image associated with an editing history;
wherein the in-browser image manipulation application is operable to:
identify a user of the in-browser image manipulation application;
retrieve at least one of the plurality of stored images from the server computer and its associated editing history; and
display a selectable image on a display at the client computer.

10. The system of claim 9 wherein the associated editing history comprises a series of image manipulations in a set order of execution.

11. The system of claim 9 wherein the associated editing history is stored at the server computer with its associated image.

12. The system of claim 9 wherein the associated editing history is stored at a second server computer communicatively coupled to the computer network.

13. The system of claim 9 wherein the client computer is further operable to provide a means for the user to undo a manipulation from the associated editing history, redo a manipulation from the associated history, execute a new manipulation, and save a new editing history.

14. The system of claim 9 further comprising a second server computer communicatively coupled to the client computer via the computer network, the second server computer having at least one additional image stored thereon, the image associated with the user of the client computer and retrievable by the client computer via an authentication negotiation over the computer network.

15. A computer readable medium having computer-executable instructions for:
identifying a user of an in-browser photo-editing application;
retrieving a plurality of digital photographs from a data store, the plurality of digital photographs associated with at least one previous photo-editing session of the identified user; and
presenting selectable images of the retrieved digital photographs on a display, each image having an associated editing history.

16. The computer readable medium of claim 15 having further computer-executable instructions for:
receiving a user input to select one of the plurality of digital photographs;
retrieving the editing history including manipulation instructions associated with the at least one previous photo-editing session; and
displaying a user interface operable to undo at least one of the manipulation instructions.

17. The computer readable medium of claim 15 having further computer-executable instructions for storing a new editing history in an associated data store, the new editing history associated with the retrieved image.

18. In an in-browser image editing computer application, a method comprising:
displaying an image for manipulation;
manipulating the image in a series of user-selected image manipulation instructions; and
saving a copy of the image after each manipulation in a data store; wherein each saved copy of the image corresponds to a rendered image just prior to the next manipulation in the series of user-selected image manipulations.

19. The method of claim 18, further comprising storing saved copies of the image at a data store that is in a remote location with respect to in-browser image editing computer application.

20. The method of claim 18, further comprising storing instructions with each copy of the image for undoing the image manipulation.
